(19) United States
(12) Patent Application Publication
(10) Pub. No.: US 2026/0236367 A1
(43) Pub. Date: Aug. 13, 2026

(54) SYSTEM STARTING METHOD AND APPARATUS, STORAGE MEDIUM, AND ELECTRONIC DEVICE

(71) Applicant: SHENZHEN TCL NEW TECHNOLOGY CO., LTD., Shenzhen, Guangdong (CN)

(72) Inventor: Weikai SONG, Shenzhen, Guangdong (CN)

(73) Assignee: SHENZHEN TCL NEW TECHNOLOGY CO., LTD., Shenzhen, Guangdong (CN)

(21) Appl. No.: 19/155,938

(22) PCT Filed: Feb. 6, 2024
(86) PCT No.: PCT/CN2024/076226

§ 371 Date: Aug. 12, 2025

(30) Foreign Application Priority Data
Feb. 13, 2023 (CN) 202310139558.7

(51) Int. Cl. G06F 11/34; G06F 11/30

(52) U.S. Cl. CPC G06F 11/3485; G06F 11/3041; G06F 11/3055

(57) ABSTRACT

Disclosed are a system starting method and apparatus, a storage medium, and an electronic device, relating to the technical field of computers. The method includes during a target system starting process, collecting a target outside loading event, obtaining outside loading content from the outside, and converting into a data file and a memory address, before a scheduled start item starts, pre-reading the data file to a memory according to the memory address by a pre-reading process. System starting efficiency is improved, and device starting speed is increased.

This application claims priority to Chinese Patent Applications No. 202310139558.7, filed on Feb. 13, 2023 and entitled “SYSTEM STARTING METHOD AND APPARATUS, STORAGE MEDIUM, AND ELECTRONIC DEVICE”. The entire disclosures of the above application are incorporated herein by reference.

### TECHNICAL FIELD

The embodiments of the present application relate to the field of computer technology, and more specifically, to a system starting method and apparatus, a storage medium, and an electronic device.

### BACKGROUND TECHNOLOGY

In devices such as televisions, during system startup, certain startup items frequently access storage peripherals such as an embedded multimedia card (eMMC) to read and load the data required during the boot phase. As the system is frequently upgraded after reaching the user, the amount of required data continues to increase. Frequent access to peripherals by these startup items can cause severe I/O load during the boot phase, resulting in delays in completing the loading of the startup items. This blocks the system startup process during the boot phase, causing slower system startup and device boot speed, thereby affecting user experience.

### Technical Problem

Frequent access to peripherals by startup items can cause severe I/O load during the boot phase, resulting in delays in completing the loading of the startup items. This blocks the system startup process during the boot phase, causing slower system startup and device boot speed, thereby affecting user experience.

### SUMMARY OF INVENTION

The embodiments of the present application provide a solution that can effectively improve system startup efficiency, increase device boot speed, and enhance user experience.

The embodiments of the present application provide the following technical solution:

According to one embodiment of the present application, a system starting method, comprising: during a target system starting process, collecting a target peripheral loading event required by a predetermined start item according to a buried point in a kernel for a peripheral loading event of the predetermined start item; obtaining a peripheral loading content corresponding to the target peripheral loading event from a peripheral; converting the peripheral loading content into a data file and a corresponding memory address for use by the predetermined start item, and generating a pre-read file list based on the data file and the corresponding memory address; recording the pre-read file list, wherein the pre-read file list is used in a subsequent target system starting process for a pre-reading process to pre-read the data file into a memory according to the corresponding memory address before the predetermined start item starts, and the data file is available for loading after the predetermined start item starts.

According to one embodiment of the present application, converting the peripheral loading content into the data file and the corresponding memory address for use by the predetermined start item, and generating the pre-read file list based on the data file and the corresponding memory address, comprises: acquiring a plurality of candidate peripheral loading contents, each of the candidate peripheral loading contents being acquired during one starting process of the target system; selecting an optimal peripheral loading content from among the plurality of candidate peripheral loading contents and the peripheral loading content; converting an optimal peripheral loading content into the data file and the corresponding memory address for use by the predetermined start item, and generating the pre-read file list based on the data file and the corresponding memory address.

According to one embodiment of the present application, the predetermined start item comprises a parent process, and the pre-read file list comprises the pre-read file list corresponding to the parent process; and after recording the pre-read file list, the method further comprises: before the parent process starts in the subsequent target system starting process, pre-reading, by the pre-reading process, the data file corresponding to the parent process into the memory from the pre-read file list corresponding to the parent process according to the corresponding memory address; loading, by the parent process, the data file corresponding to the parent process from the memory to execute a system starting procedure.

According to one embodiment of the present application, the predetermined start item comprises a system service, and the pre-read file list comprises the pre-read file list corresponding to the system service; and after recording the pre-read file list, the method further comprises: before the system service starts in the subsequent target system starting process, pre-reading, by the pre-reading process, the data file corresponding to the system service into the memory from the pre-read file list corresponding to the system service according to the corresponding memory address; loading, by the system service, the data file corresponding to the system service from the memory to execute a system starting procedure.

According to one embodiment of the present application, after recording the pre-read file list, the method further comprises: generating, in a predetermined directory, a learning completion marker configured to indicate that the pre-read file list is valid; wherein the method further comprises: in the subsequent target system starting process, detecting, by the pre-reading process, whether the learning completion marker exists in the predetermined directory to obtain a detection result; determining, by the pre-reading process, whether to execute a pre-reading mechanism corresponding to the pre-read file list based on the detection result.

According to one embodiment of the present application, after recording the pre-read file list, the method further comprises: if detecting that a target system has been updated, then during a starting process of the target system after updating, collecting an updated peripheral loading event required by the predetermined start item according to the buried point in the kernel for the peripheral loading event of the predetermined start item; obtaining an updated peripheral loading content corresponding to the updated peripheral loading event from the peripheral; converting the updated peripheral loading content into the data file and the corresponding memory address for use by the predetermined start item, and generating an updated pre-read file list based on the data file and the corresponding memory address; recording the updated pre-read file list.

According to one embodiment of the present application, after recording the pre-read file list, the method further comprises: recording, in a specified directory, a scenario marker configured to indicate that a pre-reading mechanism is invalid under a scenario corresponding to the scenario marker; wherein the method further comprises: in the subsequent target system starting process, detecting, by the pre-reading process, whether a system is in the scenario corresponding to the scenario marker to obtain a scenario information; determining, by the pre-reading process, whether to execute the pre-reading mechanism corresponding to the pre-read file list based on the scenario information.

According to one embodiment of the present application, a system starting apparatus, comprising: a collecting module configured to collect a target peripheral loading event required by a predetermined start item during a target system starting process according to a buried point in a kernel for a peripheral loading event of the predetermined start item; an acquiring module configured to obtain a peripheral loading content corresponding to the target peripheral loading event from a peripheral; a generating module configured to convert the peripheral loading content into a data file and a corresponding memory address for use by the predetermined start item, and to generate a pre-read file list based on the data file and the corresponding memory address; a recording module configured to record the pre-read file list, wherein the pre-read file list is used in a subsequent target system starting process for a pre-reading process to pre-read the data file into a memory according to the corresponding memory address before the predetermined start item starts, and the data file is available for loading after the predetermined start item starts.

According to one embodiment of the present application, the generating module is configured to: acquire a plurality of candidate peripheral loading contents, each of the candidate peripheral loading contents being acquired during one starting process of a target system; select an optimal peripheral loading content from among the plurality of candidate peripheral loading contents and a peripheral loading content; convert the optimal peripheral loading content into a data file and a corresponding memory address for use by the predetermined start item, and generate a pre-read file list based on the data file and the corresponding memory address.

According to one embodiment of the present application, the predetermined start item comprises a parent process, and the pre-read file list comprises a pre-read file list corresponding to the parent process; the apparatus further comprises a first starting module, configured to: before the parent process starts in the subsequent target system starting process, pre-read, by the pre-reading process, the data file corresponding to the parent process into a memory from the pre-read file list corresponding to the parent process according to the corresponding memory address; and load, by the parent process, the data file corresponding to the parent process from the memory to execute a system starting procedure.

According to one embodiment of the present application, the predetermined start item comprises a system service, and the pre-read file list comprises a pre-read file list corresponding to the system service; the apparatus further comprises a second starting module, configured to: before the system service starts in the subsequent target system starting process, pre-read, by the pre-reading process, the data file corresponding to the system service into a memory from the pre-read file list corresponding to the system service according to the corresponding memory address; and load, by the system service, the data file corresponding to the system service from the memory to execute a system starting procedure.

According to one embodiment of the present application, the apparatus further comprises a learning marker generation module, configured to: generate, in a predetermined directory, a learning completion marker configured to indicate that the pre-read file list is valid; and further comprises a learning marker detection module, configured to: in the subsequent target system starting process, detect, by the pre-reading process, whether the learning completion marker exists in the predetermined directory to obtain a detection result; and determine, by the pre-reading process, whether to execute a pre-reading mechanism corresponding to the pre-read file list based on the detection result.

According to one embodiment of the present application, the apparatus further comprises an updating module, configured to: if detecting that a target system has been updated, then during a starting process of the target system after updating, collect an updated peripheral loading event required by the predetermined start item according to the buried point in the kernel for the peripheral loading event of the predetermined start item; obtain updated peripheral loading content corresponding to the updated peripheral loading event from a peripheral; convert the updated peripheral loading content into a data file and a corresponding memory address for use by the predetermined start item, and generate an updated pre-read file list based on the data file and the corresponding memory address; and record the updated pre-read file list.

According to one embodiment of the present application, the apparatus further comprises a scenario marker recording module, configured to: record, in a specified directory, a scenario marker configured to indicate that a pre-reading mechanism is invalid under a scenario corresponding to the scenario marker; and further comprises a scenario marker detection module, configured to: in the subsequent target system starting process, detect, by the pre-reading process, whether a system is in the scenario corresponding to the scenario marker to obtain a scenario information; and determine, by the pre-reading process, whether to execute the pre-reading mechanism corresponding to the pre-read file list based on the scenario information.

According to another embodiment of the present application, a storage medium is provided, on which a computer program is stored. When the computer program is executed by a processor of a computer, the computer is caused to perform the method described in the embodiments of the present application.

According to another embodiment of the present application, an electronic device is provided, comprising: a memory storing a computer program; and a processor configured to read the computer program stored in the memory to perform the method described in the embodiments of the present application.

According to another embodiment of the present application, a computer program product or computer program is provided, the computer program product or computer program comprising computer instructions stored in a computer-readable storage medium. A processor of a computer device reads the computer instructions from the computer-readable storage medium and executes the computer instructions, such that the computer device performs the method provided in various optional implementations described in the embodiments of the present application.

### Beneficial Effects

In the embodiments of the present application, during a target system starting process, a target peripheral loading event required by a predetermined start item is collected according to a buried point in a kernel for a peripheral loading event of the predetermined start item; peripheral loading content corresponding to the target peripheral loading event is obtained from a peripheral; the peripheral loading content is converted into a data file and a corresponding memory address for use by the predetermined start item, and a pre-read file list is generated based on the data file and the memory address; the pre-read file list is recorded, wherein the pre-read file list is used in a subsequent target system starting process for a pre-reading process to pre-read the data file into memory according to the memory address before the predetermined start item starts, and the data file is available for loading after the predetermined start item starts.

In this way, for the predetermined start item in the target system, the target peripheral loading event required for its startup is collected through buried points, and the peripheral loading content corresponding to the target peripheral loading event is obtained from the peripheral. The peripheral loading content is converted into a data file and a corresponding memory address for use by the predetermined start item, and a pre-read file list is generated and recorded. Accordingly, when the target system is subsequently started, before the predetermined start item starts, the pre-reading process can preload the data file into memory based on the pre-read file list. After the predetermined start item starts, it no longer needs to access the peripheral to obtain this data, but can directly and efficiently load the data file from memory for use. As a result, the target system can complete startup efficiently, effectively improving system startup efficiency, increasing device boot speed, and enhancing user experience.

### BRIEF DESCRIPTION OF THE DRAWINGS

In order to more clearly illustrate technical solutions in embodiments of the present application, accompanying drawings required for describing the embodiments are briefly introduced below. Apparently, the drawings described below are only some embodiments of the present application. For those skilled in the art, other drawings can be obtained based on these drawings without creative efforts.

FIG. 1 shows a flowchart of a system starting method according to one embodiment of the present application.

FIG. 2 shows a flowchart of a pre-reading method according to one embodiment of the present application.

FIG. 3 shows a diagram of a file format of peripheral loading content according to one embodiment of the present application.

FIG. 4 shows a diagram of a file format of a pre-read file list according to one embodiment of the present application.

FIG. 5 shows a block diagram of a system starting apparatus according to one embodiment of the present application.

FIG. 6 shows a block diagram of an electronic device according to one embodiment of the present application.

### DETAILED DESCRIPTION OF THE EMBODIMENTS

The technical solutions in the embodiments of the present application will now be clearly and fully described with reference to the accompanying drawings. It is evident that the described embodiments are only part of the embodiments of the present application, and not all embodiments. All other embodiments obtained by those skilled in the art based on the embodiments of the present application without creative efforts shall fall within the scope of protection of the present application.

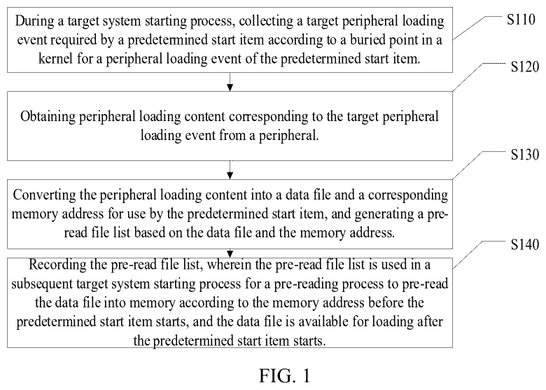

FIG. 1 schematically illustrates a flowchart of a system starting method according to one embodiment of the present application. The execution subject of the system starting method may be any device, such as a television, computer, mobile phone, smartwatch, or household appliance. In one embodiment of the present application, the device is specifically a television.

As shown in FIG. 1, the system starting method may comprise steps S110 to S140.

Step S110: during a target system starting process, collecting a target peripheral loading event required by a predetermined start item according to a buried point in a kernel for a peripheral loading event of the predetermined start item; Step S120: obtaining peripheral loading content corresponding to the target peripheral loading event from a peripheral; Step S130: converting the peripheral loading content into a data file and a corresponding memory address for use by the predetermined start item, and generating a pre-read file list based on the data file and the memory address; Step S140: recording the pre-read file list, wherein the pre-read file list is used in a subsequent target system starting process for a pre-reading process to pre-read the data file into memory according to the memory address before the predetermined start item starts, and the data file is available for loading after the predetermined start item starts.

The target system refers to the operating system installed on the device, such as a Linux system or an Android system. The predetermined start item refers to a system startup item in the target system, for example, a parent process (zygote) or a system service (system_server). The collecting module may collect peripheral loading events (I/O loading events) of the predetermined start item by using buried point markers for the peripheral loading events (I/O loading events) of the predetermined start item in the kernel, so as to obtain target peripheral loading events required by the predetermined start item. The target peripheral loading events refer to peripheral loading events collected through the buried points. The collecting module may be implemented as a dynamic link library (libiopredtrace) module, in which general functions for trace capturing can be encapsulated, and which may include buried points for specific peripheral loading events.

The acquiring module can obtain peripheral loading content corresponding to the target peripheral loading events from a peripheral. The acquiring module may also be implemented as a dynamic link library (libiopredtrace) module, in which general functions for trace capturing can be encapsulated, enabling the capture of the trace corresponding to the target peripheral loading content. Furthermore, based on the trace corresponding to the peripheral loading content, the corresponding peripheral loading content can be obtained from the peripheral. The peripheral loading content may include certain class jar packages, configuration data, so dynamic libraries, and the like.

The generating module can convert the peripheral loading content into a data file and a corresponding memory address for use by the predetermined start item, and generate a pre-read file list based on the data file and the memory address. Specifically, the generating module may receive the peripheral loading content fed back by the dynamic link library (libiopredtrace) module through a pre-reading process (treadahead), and convert and process the peripheral loading content into a data file and a corresponding memory address for use by the predetermined start item through the pre-reading process (treadahead), and parse it into the required pre-read file list, wherein treadahead is a native-layer service process.

The recording module can record the pre-read file list. During a subsequent target system starting process, before the predetermined start item starts, the pre-reading process (treadahead) can perform pre-reading through a pre-reading interface (such as a readahead interface or a posix-fadvise interface) to pre-read the data file into memory according to the memory address in the pre-read file list. After the predetermined start item starts, the data file can be loaded from memory for use.

In this way, based on steps S110 to S140, for the predetermined start item in the target system, the target peripheral loading event required for its startup is collected through buried points, and the peripheral loading content corresponding to the target peripheral loading event is obtained from the peripheral. The peripheral loading content is converted into a data file and a corresponding memory address for use by the predetermined start item, and a pre-read file list is generated and recorded. Accordingly, when the target system is subsequently started, before the predetermined start item starts, the pre-reading process can preload the data file into memory based on the pre-read file list. After the predetermined start item starts, it no longer needs to access the peripheral to obtain this data, but can directly and efficiently load the data file from memory for use. As a result, the target system can complete startup efficiently, effectively improving system startup efficiency, increasing device boot speed, and enhancing user experience.

The following describes further optional specific embodiments of the steps performed during system startup in the embodiment of FIG. 1.

In one embodiment, in step S130, converting the peripheral loading content into a data file and a corresponding memory address for use by the predetermined start item, and generating a pre-read file list based on the data file and the memory address, comprises:
Acquiring a plurality of candidate peripheral loading contents, each of the candidate peripheral loading contents being acquired during one starting process of the target system; selecting an optimal peripheral loading content from among the plurality of candidate peripheral loading contents and the peripheral loading content; converting the optimal peripheral loading content into a data file and a corresponding memory address for use by the predetermined start item, and generating a pre-read file list based on the data file and the memory address.

In this embodiment, since the content loaded by the predetermined start item at each boot may differ, multiple instances of loading content during target system startups (including the current peripheral loading content and multiple candidate peripheral loading contents) are obtained, and the optimal one is selected as the optimal peripheral loading content. The optimal peripheral loading content is converted into a data file and a corresponding memory address for use by the predetermined start item, and a pre-read file list is generated based on the data file and the memory address. In this way, the pre-reading effect of the data file based on the pre-read file list can be further improved, thereby enhancing system startup performance.

It can be understood that, in another embodiment, in step S130, converting the peripheral loading content into a data file and a corresponding memory address for use by the predetermined start item, and generating a pre-read file list based on the data file and the memory address, comprises: directly converting the current peripheral loading content into a data file and a corresponding memory address for use by the predetermined start item, and generating a pre-read file list based on the data file and the memory address.

In one embodiment, the predetermined start item comprises a parent process, and the pre-read file list comprises a pre-read file list corresponding to the parent process; after recording the pre-read file list in step S140, the method further comprises:

Before the parent process starts in a subsequent target system starting process, pre-reading, by the pre-reading process, the data file corresponding to the parent process into memory from the pre-read file list corresponding to the parent process according to the memory address; and loading, by the parent process, the data file corresponding to the parent process from the memory to execute a system starting procedure.

In this embodiment, the predetermined start item comprises a parent process (zygote), and the pre-read file list comprises a pre-read file list corresponding to the parent process. Before the parent process (zygote) starts during the target system starting process, the pre-reading process pre-reads, according to the memory address, the data file corresponding to the parent process into memory from the pre-read file list corresponding to the parent process. After the parent process starts, it can directly load the corresponding data file required by the parent process from memory to execute the system starting procedure.

In one embodiment, the predetermined start item comprises a system service, and the pre-read file list comprises a pre-read file list corresponding to the system service; after recording the pre-read file list in step S140, the method further comprises:

Before the system service starts in a subsequent target system starting process, pre-reading, by the pre-reading process, the data file corresponding to the system service into memory from the pre-read file list corresponding to the system service according to the memory address; and loading, by the system service, the data file corresponding to the system service from the memory to execute the system starting procedure.

In this embodiment, the predetermined start item comprises a system service (system_server), and the pre-read file list comprises a pre-read file list corresponding to the system service. Before the system service starts during the target system starting process, the pre-reading process pre-reads, according to the memory address, the data file corresponding to the system service into memory from the pre-read file list corresponding to the system service. After the system service starts, it can directly load the corresponding data file required by the system service from memory to execute the system starting procedure.

In one embodiment, after recording the pre-read file list, the method further comprises: generating, in a predetermined directory, a learning completion marker configured to indicate that the pre-read file list is valid; the method further comprises: in a subsequent target system starting process, detecting, by the pre-reading process, whether the learning completion marker exists in the predetermined directory to obtain a detection result; and determining, by the pre-reading process, whether to execute a pre-reading mechanism corresponding to the pre-read file list based on the detection result.

In this embodiment, after learning the pre-read file list, a learning completion marker is generated in a predetermined directory (for example, a cache directory). During a subsequent target system starting process, the pre-reading process can detect whether the learning completion marker exists in the predetermined directory to obtain the detection result.

The pre-reading process can further determine whether to execute the pre-reading mechanism corresponding to the pre-read file list based on the detection result. Specifically, if the detection result indicates that the learning completion marker exists, the pre-reading process may preload the data file into memory in advance according to the pre-read file list (i.e., execute the pre-reading mechanism). Conversely, if the detection result indicates that the learning completion marker does not exist, the pre-reading process will not preload the data file into memory according to the pre-read file list (i.e., will not execute the pre-reading mechanism). In this way, the validity of the pre-read file list is verified through the learning completion marker to trigger the pre-reading mechanism, thereby further improving the reliability of system startup.

In one embodiment, after recording the pre-read file list, the method further comprises: if it is detected that the target system has been updated, then during a starting process of the target system after the update, collecting an updated peripheral loading event required by the predetermined start item according to a buried point in a kernel for a peripheral loading event of the predetermined start item; obtaining updated peripheral loading content corresponding to the updated peripheral loading event from a peripheral; converting the updated peripheral loading content into a data file and a corresponding memory address for use by the predetermined start item; and generating an updated pre-read file list based on the data file and the memory address; and recording the updated pre-read file list.

After the target system is updated, the loading events of the predetermined start item may change. Upon detecting that the target system has been updated, an updated pre-read file list is generated and recorded by collecting updated peripheral loading events required by the predetermined start item. The pre-reading process can execute the pre-reading mechanism based on the updated pre-read file list, thereby further enhancing the startup reliability of the target system.

In one embodiment, after recording the pre-read file list, the method further comprises: recording, in a specified directory, a scenario marker configured to indicate that the pre-reading mechanism is invalid under a scenario corresponding to the scenario marker; the method further comprises: in a subsequent target system starting process, detecting, by the pre-reading process, whether the system is in the scenario corresponding to the scenario marker to obtain scenario information; and determining, by the pre-reading process, whether to execute a pre-reading mechanism corresponding to the pre-read file list based on the scenario information.

In this embodiment, by recording the scenario marker in a specified directory (for example, a cache directory), the pre-reading process can detect during a subsequent target system startup whether the target system is in the scenario corresponding to the scenario marker (for example, a production line scenario or a scenario where the boot wizard has not been completed).

The pre-reading process can further determine whether to execute the pre-reading mechanism corresponding to the pre-read file list based on the detected scenario information. Specifically, if the scenario information indicates that the system is not in the scenario corresponding to the scenario marker, the pre-reading process may preload the data file into memory in advance according to the pre-read file list (i.e., execute the pre-reading mechanism). Conversely, if the scenario information indicates that the system is in the scenario corresponding to the scenario marker, the pre-reading process will not preload the data file into memory according to the pre-read file list (i.e., will not execute the pre-reading mechanism). In this way, the reliability of system startup can be further improved.

It can be understood that, in the foregoing embodiments, after recording the pre-read file list or the updated pre-read file list, the process may also simply involve deleting the old pre-read file list in the target system.

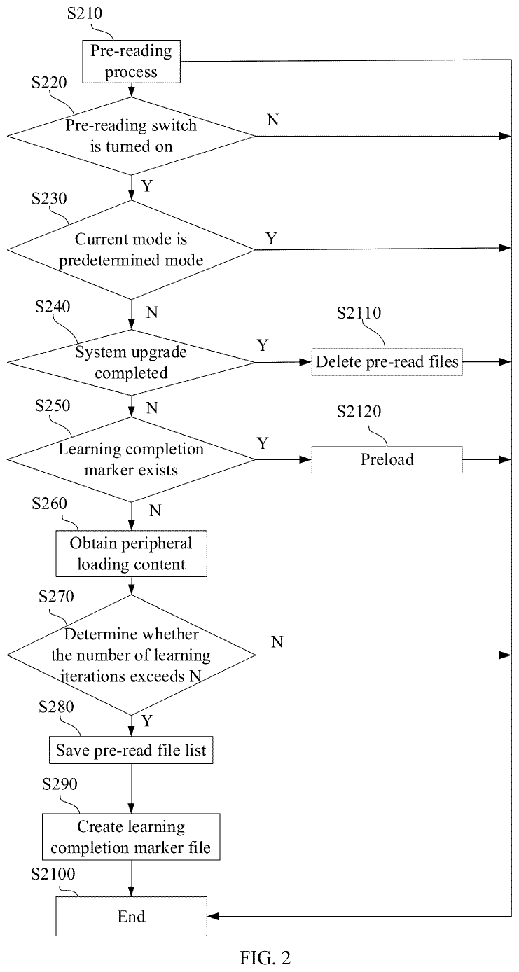

The following further describes the foregoing embodiments in conjunction with a system startup process in one scenario, where the system startup is performed by applying the foregoing embodiments of the present application. In this scenario, referring to FIG. 2, the system startup process may comprise steps S210 to S2120.

Step S210: start the “pre-reading process,” wherein after the target system is triggered to start, the pre-reading process is started, specifically as the treadahead process.

Step S220: determine whether the “pre-reading switch is turned on,” wherein a predetermined directory (cache directory) may store a pre-read enable switch file corresponding to the predetermined start item. According to the switch information in the pre-read enable switch file, it can be determined whether the pre-reading switch corresponding to the predetermined start item is turned on.

For example, if the predetermined start item is the parent process (zygote), and the pre-read enable switch file contains name: zygote-enable and the corresponding value: true, then the pre-reading switch for the parent process (zygote) is turned on. Otherwise, if the value is false, then the pre-reading switch for the parent process (zygote) is turned off.

Furthermore, if the pre-reading switch is turned on (Y), step S230 is executed; if the pre-reading switch is turned off (N), step S2100 is executed, and the process ends, meaning the pre-reading process does not execute the pre-reading mechanism.

Step S230: determine whether the “current mode is the predetermined mode,” wherein if the current mode is not the predetermined mode (N), step S240 is executed; if the current mode is the predetermined mode (Y), step S2100 is executed and the process ends, meaning the pre-reading process does not execute the pre-reading mechanism.

Specifically, this may involve detecting, by the pre-reading process, whether the system is in the scenario corresponding to the scenario marker in the specified directory to obtain scenario information, and further determining, based on the scenario information, whether to execute the pre-reading mechanism corresponding to the pre-read file list. By recording the scenario marker in a specified directory (for example, the cache directory), the pre-reading process can detect, during the target system startup process, whether the target system is in the scenario corresponding to the scenario marker (for example, a production line scenario or a scenario where the boot wizard has not been completed).

The pre-reading process can further determine, based on the detected scenario information, whether to execute the pre-reading mechanism corresponding to the pre-read file list. Specifically, if the scenario information indicates that the system is not in the scenario corresponding to the scenario marker (i.e., the current mode is not the predetermined mode), the pre-reading process may further proceed to step S240; conversely, if the scenario information indicates that the system is in the scenario corresponding to the scenario marker (i.e., the current mode is the predetermined mode), the pre-reading process will proceed to step S2100.

Step S240: determine whether “system upgrade is completed.” If yes (Y), proceed to step S2110 to delete pre-read files, where the pre-read files may include the old pre-read file list, the old learning completion marker, the old database of the predetermined start item, and old trace files, etc., and then further proceed to step S2100 to end the process. In this case, a “yes” (Y) indicates that the target system has been updated, and the old pre-read files are not applicable for executing the pre-reading mechanism during startup of the updated target system. If no (N), proceed to step S250.

Step S250: determine whether the “learning completion marker exists.”

If it exists (Y), proceed to step S2120. In step S2120, perform “preloading,” i.e., the pre-reading process detects whether the learning completion marker exists in the predetermined directory to obtain the detection result; the pre-reading process determines whether to execute the pre-reading mechanism corresponding to the pre-read file list based on the detection result. Specifically, if the detection result indicates that the learning completion marker exists, the pre-reading process may preload the data file into memory in advance according to the pre-read file list (i.e., execute the pre-reading mechanism). Conversely, if the detection result indicates that the learning completion marker does not exist, the pre-reading process will not preload the data file into memory according to the pre-read file list (i.e., will not execute the pre-reading mechanism).

Conversely, if it does not exist (N), proceed to step S260.

Step S260: obtain peripheral loading content.

Specifically, during the target system starting process, a target peripheral loading event required by a predetermined start item is collected according to a buried point in a kernel for a peripheral loading event of the predetermined start item; and peripheral loading content corresponding to the target peripheral loading event is obtained from a peripheral.

The predetermined start item refers to a system startup item in the target system, for example, a parent process (zygote) or a system service (system_server). The collecting module may collect peripheral loading events (I/O loading events) of the predetermined start item by using buried point markers for the peripheral loading events (I/O loading events) of the predetermined start item in the kernel, so as to obtain target peripheral loading events required by the predetermined start item. The target peripheral loading events refer to peripheral loading events collected through the buried points.

The collecting module may be implemented as a dynamic link library (libiopredtrace) module, in which general functions for trace capturing can be encapsulated, and which may include buried points for specific peripheral loading events.

The acquiring module can obtain peripheral loading content corresponding to the target peripheral loading event from a peripheral. The acquiring module may be implemented as a dynamic link library (libiopredtrace) module, in which general functions for trace capturing can be encapsulated. It can capture the trace corresponding to the target peripheral loading content to form a trace file. Furthermore, based on the trace corresponding to the peripheral loading content, the corresponding peripheral loading content can be obtained from the peripheral. The peripheral loading content may include certain class JAR packages, configuration data, shared object (SO) dynamic libraries, and the like.

Step S270: determine whether “the number of learning iterations exceeds N,” wherein N may specifically be equal to 3.

If the number of learning iterations has not exceeded N (N), proceed to step S2100. If the number of learning iterations has exceeded N (Y), proceed to step S280. Each learning iteration may obtain one set of peripheral loading content corresponding to the predetermined start item.

Step S280: save the pre-read file list, i.e., convert the peripheral loading content into a data file and a corresponding memory address for use by the predetermined start item, and generate a pre-read file list based on the data file and the memory address; record the pre-read file list.

Specifically, this may comprise: acquiring a plurality of candidate peripheral loading contents, each candidate peripheral loading content being acquired during one starting process of the target system; selecting an optimal peripheral loading content from among the plurality of candidate peripheral loading contents and the peripheral loading content; converting the optimal peripheral loading content into a data file and a corresponding memory address for use by the predetermined start item, and generating a pre-read file list based on the data file and the memory address.

Where the number of learning iterations is 3, the candidate peripheral loading contents are 2, with each candidate peripheral loading content being acquired during one starting process of the target system (i.e., one peripheral loading content can be obtained from each startup process), and the current learning iteration also obtains one peripheral loading content.

The generating module can convert the optimal peripheral loading content into a data file and a corresponding memory address for use by the predetermined start item, and generate a pre-read file list based on the data file and the memory address. Specifically, the generating module may receive the optimal peripheral loading content fed back by the dynamic link library (libiopredtrace) module through the pre-reading process (treadahead), and convert and process the optimal peripheral loading content into a data file and a corresponding memory address for use by the predetermined start item through the pre-reading process (treadahead), and parse it into the required pre-read file list, wherein treadahead is a native-layer service process.

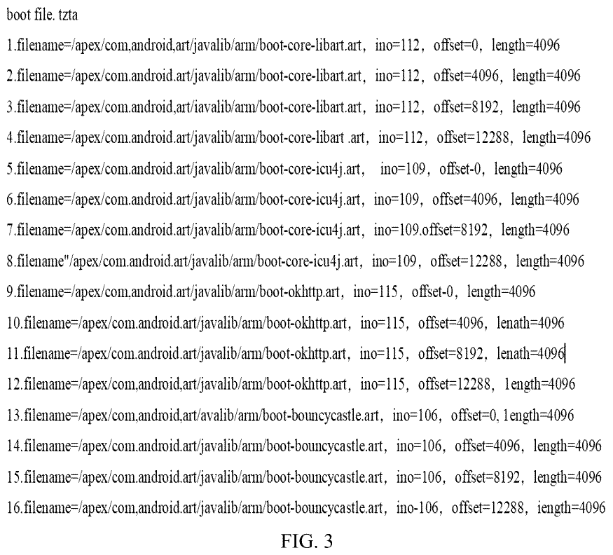

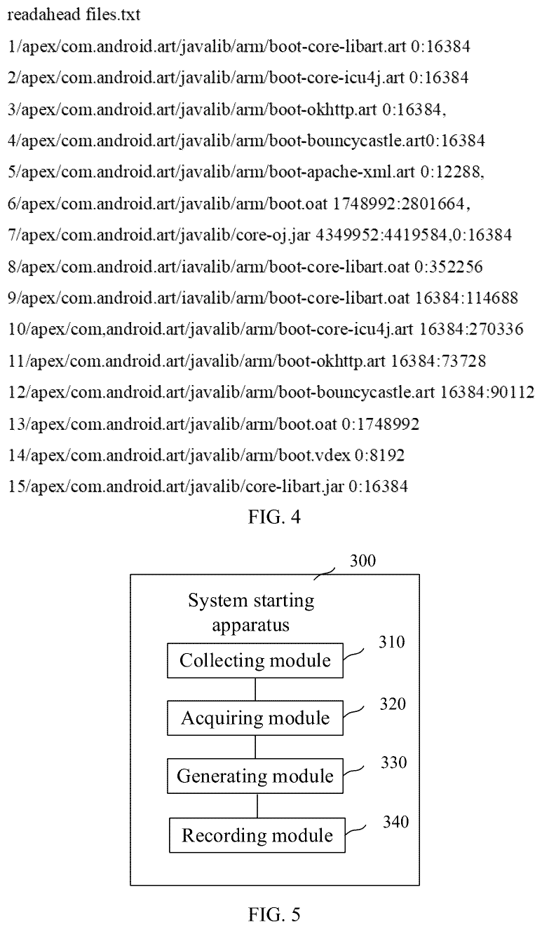

Referring to FIG. 3, a file format corresponding to one peripheral loading content is shown. In this format, filename represents the absolute path (trace) of the data file, ino represents the inode number, offset represents the offset address, and length represents the read length. Referring to FIG. 4, the file format of the pre-read file list saved after conversion is shown. In this format, files such as .art or .oat are data files, which are located based on the absolute path and inode number (ino). The memory address may include a start address and an offset, for example, 0:16384.

Step S290: create a learning completion marker. A learning completion marker is generated in a predetermined directory, which is used to indicate that the pre-read file list is valid.

During a subsequent target system starting process, the pre-reading process detects whether the learning completion marker exists in the predetermined directory to obtain the detection result; based on the detection result, the pre-reading process can determine whether to execute the pre-reading mechanism corresponding to the pre-read file list. Specifically, if the detection result indicates that the learning completion marker exists, the pre-reading process may preload the data file into memory in advance according to the pre-read file list (i.e., execute the pre-reading mechanism). Conversely, if the detection result indicates that the learning completion marker does not exist, the pre-reading process will not preload the data file into memory according to the pre-read file list (i.e., will not execute the pre-reading mechanism).

In this way, in the above scenario, by applying the foregoing embodiments of the present application, before the pre-read start item starts during target system startup, the pre-reading process can preload the data file into memory in advance according to the pre-read file list. After the predetermined start item starts, it does not need to access the peripheral to obtain this data; instead, it can directly and efficiently load the data file from memory for use. As a result, the target system can complete startup efficiently, effectively improving system startup efficiency, increasing device boot speed, and enhancing user experience.

To better implement the system starting method provided in the embodiments of the present application, the embodiments of the present application also provide a system starting apparatus based on the above system starting method. The meanings of the terms are the same as those in the above system starting method, and specific implementation details can be referred to in the description of the method embodiments. FIG. 5 shows a block diagram of a system starting apparatus according to one embodiment of the present application.

As shown in FIG. 5, a system starting apparatus 500 may include: a collecting module 310 configured to, during a target system starting process, collect a target peripheral loading event required by a predetermined start item according to a buried point in a kernel for a peripheral loading event of the predetermined start item; an acquiring module 320 configured to obtain peripheral loading content corresponding to the target peripheral loading event from a peripheral; a generating module 330 configured to convert the peripheral loading content into a data file and a corresponding memory address for use by the predetermined start item, and generate a pre-read file list based on the data file and the memory address; and a recording module 340 configured to record the pre-read file list, wherein the pre-read file list is used in a subsequent target system starting process for a pre-reading process to pre-read the data file into memory according to the memory address before the predetermined start item starts, and the data file is available for loading after the predetermined start item starts.

In some embodiments of the present application, the generating module is configured to: acquire a plurality of candidate peripheral loading contents, each of the candidate peripheral loading contents being acquired during one starting process of the target system; select an optimal peripheral loading content from among the plurality of candidate peripheral loading contents and the peripheral loading content; convert the optimal peripheral loading content into a data file and a corresponding memory address for use by the predetermined start item, and generate a pre-read file list based on the data file and the memory address.

In some embodiments of the present application, the predetermined start item comprises a parent process, and the pre-read file list comprises a pre-read file list corresponding to the parent process; the apparatus further comprises a first starting module configured to: before the parent process starts in a subsequent target system starting process, pre-read, by the pre-reading process, the data file corresponding to the parent process into memory from the pre-read file list corresponding to the parent process according to the memory address; and load, by the parent process, the data file corresponding to the parent process from the memory to execute the system starting procedure.

In some embodiments of the present application, the predetermined start item comprises a system service, and the pre-read file list comprises a pre-read file list corresponding to the system service; the apparatus further comprises a second starting module configured to: before the system service starts in a subsequent target system starting process, pre-read, by the pre-reading process, the data file corresponding to the system service into memory from the pre-read file list corresponding to the system service according to the memory address; and load, by the system service, the data file corresponding to the system service from the memory to execute the system starting procedure.

In some embodiments of the present application, the apparatus further comprises a learning marker generation module configured to: generate, in a predetermined directory, a learning completion marker configured to indicate that the pre-read file list is valid; and a learning marker detection module configured to: in a subsequent target system starting process, detect, by the pre-reading process, whether the learning completion marker exists in the predetermined directory to obtain a detection result; and determine, by the pre-reading process, whether to execute a pre-reading mechanism corresponding to the pre-read file list based on the detection result.

In some embodiments of the present application, the apparatus further comprises an updating module configured to: if it is detected that the target system has been updated, then during a starting process of the target system after the update, collect an updated peripheral loading event required by the predetermined start item according to a buried point in a kernel for a peripheral loading event of the predetermined start item; obtain updated peripheral loading content corresponding to the updated peripheral loading event from a peripheral; convert the updated peripheral loading content into a data file and a corresponding memory address for use by the predetermined start item, and generate an updated pre-read file list based on the data file and the memory address; and record the updated pre-read file list.

In some embodiments of the present application, the apparatus further comprises a scenario marker recording module configured to: record, in a specified directory, a scenario marker configured to indicate that the pre-reading mechanism is invalid under a scenario corresponding to the scenario marker; and a scenario marker detection module configured to: in a subsequent target system starting process, detect, by the pre-reading process, whether the system is in the scenario corresponding to the scenario marker to obtain scenario information; and determine, by the pre-reading process, whether to execute a pre-reading mechanism corresponding to the pre-read file list based on the scenario information.

It should be noted that although several modules or units of the device for performing operations have been mentioned in the above detailed description, such division is not mandatory. In fact, according to the embodiments of the present application, the features and functions of two or more of the above-described modules or units may be embodied in one module or unit. Conversely, the features and functions of one of the above-described modules or units may be further divided and embodied by multiple modules or units.

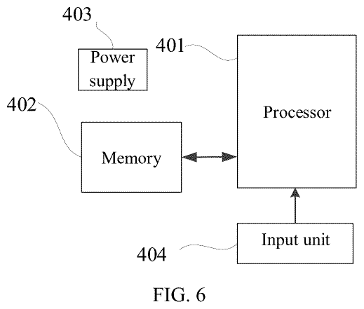

In addition, the embodiments of the present application also provide an electronic device, which may be a terminal or a server. As shown in FIG. 6, which illustrates a schematic structural diagram of an electronic device involved in the embodiments of the present application, specifically:

The electronic device may include a processor 401 having one or more processing cores, a memory 402 comprising one or more computer-readable storage media, a power supply 403, and an input unit 404, among other components. Those skilled in the art will understand that the structure of the electronic device shown in FIG. 6 does not limit the electronic device and may include more or fewer components than illustrated, or combine certain components, or arrange components in different configurations.

The processor 401 serves as the control center of the electronic device, connecting various parts of the entire computer device through various interfaces and circuits. By running or executing software programs and/or modules stored in the memory 402, and by invoking data stored in the memory 402, the processor 401 performs various functions of the computer device and processes data, thereby providing overall control of the electronic device. Optionally, the processor 401 may include one or more processing cores; preferably, the processor 401 may integrate an application processor and a modem processor, wherein the application processor primarily handles the operating system, user interface, and applications, while the modem processor primarily handles wireless communication. It will be understood that the above-mentioned modem processor may also be implemented separately from the processor 401.

The memory 402 may be used for storing software programs and modules. The processor 401 executes various functional applications and data processing tasks by running the software programs and modules stored in the memory 402. The memory 402 may include a program storage area and a data storage area, wherein the program storage area may store the operating system, at least one application program required for a function (such as audio playback, image playback, etc.), and the like; the data storage area may store data created during use of the computer device, among other things. In addition, the memory 402 may include high-speed random access memory, and may also include non-volatile memory, such as at least one disk storage device, flash memory device, or other non-volatile solid-state storage device. Correspondingly, the memory 402 may further include a memory controller to provide the processor 401 with access to the memory 402.

The electronic device further includes a power supply 403 for supplying power to the various components. Preferably, the power supply 403 may be logically connected to the processor 401 through a power management system, thereby enabling the power management system to manage charging, discharging, and power consumption control functions. The power supply 403 may further include any combination of one or more direct current (DC) or alternating current (AC) power sources, a recharging system, a power failure detection circuit, a power converter or inverter, a power status indicator, and the like.

The electronic device may also include an input unit 404, which can be used to receive numeric or character input, as well as to generate keyboard, mouse, joystick, optical, or trackball signal inputs related to user settings and function control.

Although not shown, the electronic device may also include a display unit and other components, which are not further described herein. Specifically, in the present embodiment, the processor 401 of the electronic device executes instructions to load the executable file corresponding to one or more processes of a computer program into the memory 402, and runs the computer program stored in the memory 402 via the processor 401, thereby implementing various functions described in the foregoing embodiments of the present application. For example, the processor 401 may perform the following steps:

During the target system starting process, a target peripheral loading event required by a predetermined start item is collected according to a buried point in a kernel for a peripheral loading event of the predetermined start item; peripheral loading content corresponding to the target peripheral loading event is obtained from a peripheral; the peripheral loading content is converted into a data file and a corresponding memory address for use by the predetermined start item, and a pre-read file list is generated based on the data file and the memory address; the pre-read file list is recorded, wherein the pre-read file list is used in a subsequent target system starting process for a pre-reading process to pre-read the data file into memory according to the memory address before the predetermined start item starts, and the data file is available for loading after the predetermined start item starts.

In some embodiments of the present application, converting the peripheral loading content into a data file and a corresponding memory address for use by the predetermined start item, and generating a pre-read file list based on the data file and the memory address, comprises: acquiring a plurality of candidate peripheral loading contents, each of the candidate peripheral loading contents being acquired during one starting process of the target system; selecting an optimal peripheral loading content from among the plurality of candidate peripheral loading contents and the peripheral loading content; converting the optimal peripheral loading content into a data file and a corresponding memory address for use by the predetermined start item, and generating a pre-read file list based on the data file and the memory address.

In some embodiments of the present application, the predetermined start item comprises a parent process, and the pre-read file list comprises a pre-read file list corresponding to the parent process; after recording the pre-read file list, the method may further comprise: before the parent process starts in a subsequent target system starting process, pre-reading, by the pre-reading process, the data file corresponding to the parent process into memory from the pre-read file list corresponding to the parent process according to the memory address; and loading, by the parent process, the data file corresponding to the parent process from the memory to execute the system starting procedure.

In some embodiments of the present application, the predetermined start item comprises a system service, and the pre-read file list comprises a pre-read file list corresponding to the system service; after recording the pre-read file list, the method may further comprise: before the system service starts in a subsequent target system starting process, pre-reading, by the pre-reading process, the data file corresponding to the system service into memory from the pre-read file list corresponding to the system service according to the memory address; and loading, by the system service, the data file corresponding to the system service from the memory to execute the system starting procedure.

In some embodiments of the present application, after recording the pre-read file list, the method may further comprise: generating, in a predetermined directory, a learning completion marker configured to indicate that the pre-read file list is valid; and further comprising: in a subsequent target system starting process, detecting, by the pre-reading process, whether the learning completion marker exists in the predetermined directory to obtain a detection result; and determining, by the pre-reading process, whether to execute a pre-reading mechanism corresponding to the pre-read file list based on the detection result.

In some embodiments of the present application, after recording the pre-read file list, the method may further comprise: if it is detected that the target system has been updated, then during a starting process of the target system after the update, collecting an updated peripheral loading event required by the predetermined start item according to a buried point in a kernel for a peripheral loading event of the predetermined start item; obtaining updated peripheral loading content corresponding to the updated peripheral loading event from a peripheral; converting the updated peripheral loading content into a data file and a corresponding memory address for use by the predetermined start item, and generating an updated pre-read file list based on the data file and the memory address; and recording the updated pre-read file list.

In some embodiments of the present application, after recording the pre-read file list, the method may further comprise: recording, in a specified directory, a scenario marker configured to indicate that the pre-reading mechanism is invalid under a scenario corresponding to the scenario marker; the method further comprises: in a subsequent target system starting process, detecting, by the pre-reading process, whether the system is in the scenario corresponding to the scenario marker to obtain scenario information; and determining, by the pre-reading process, whether to execute a pre-reading mechanism corresponding to the pre-read file list based on the scenario information.

Those of ordinary skill in the art will understand that all or part of the steps in the various methods of the above embodiments may be implemented by a computer program, or by controlling related hardware through a computer program. The computer program may be stored in a computer-readable storage medium and loaded and executed by a processor.

To this end, the embodiments of the present application further provide a storage medium, in which a computer program is stored, the computer program being loadable by a processor to perform the steps of any of the methods provided in the embodiments of the present application.

The storage medium may include, for example, read-only memory (ROM), random access memory (RAM), a disk, or an optical disc.

Since the computer program stored in the storage medium can execute the steps of any of the methods provided in the embodiments of the present application, it can achieve the beneficial effects attainable by the methods provided in the embodiments of the present application, as detailed in the foregoing embodiments, and will not be repeated here.

Those skilled in the art, upon consideration of the specification and practice of the embodiments disclosed herein, will readily conceive of other embodiments of the present application. The present application is intended to cover any modifications, applications, or adaptive changes that follow the general principles of the present application and include well-known common knowledge or conventional technical means in the art that are not disclosed in the present application.

It should be understood that the present application is not limited to the embodiments described above and shown in the accompanying drawings, and that various modifications and changes may be made without departing from the scope thereof.

1. A system starting method, comprising:
during a target system starting process, collecting a target peripheral loading event required by a predetermined start item according to a buried point in a kernel for a peripheral loading event of the predetermined start item;
obtaining a peripheral loading content corresponding to the target peripheral loading event from a peripheral;
converting the peripheral loading content into a data file and a corresponding memory address for use by the predetermined start item, and generating a pre-read file list based on the data file and the corresponding memory address;
recording the pre-read file list, wherein the pre-read file list is used in a subsequent target system starting process for a pre-reading process to pre-read the data file into a memory according to the corresponding memory address before the predetermined start item starts, and the data file is available for loading after the predetermined start item starts.

2. The method according to claim 1, wherein converting the peripheral loading content into the data file and the corresponding memory address for use by the predetermined start item, and generating the pre-read file list based on the data file and the corresponding memory address, comprises:
acquiring a plurality of candidate peripheral loading contents, each of the candidate peripheral loading contents being acquired during one starting process of the target system;
selecting an optimal peripheral loading content from among the plurality of candidate peripheral loading contents and the peripheral loading content;
converting an optimal peripheral loading content into the data file and the corresponding memory address for use by the predetermined start item, and generating the pre-read file list based on the data file and the corresponding memory address.

3. The method according to claim 1, wherein the predetermined start item comprises a parent process, and the pre-read file list comprises the pre-read file list corresponding to the parent process; and after recording the pre-read file list, the method further comprises:
before the parent process starts in the subsequent target system starting process, pre-reading, by the pre-reading process, the data file corresponding to the parent process into the memory from the pre-read file list corresponding to the parent process according to the corresponding memory address;
loading, by the parent process, the data file corresponding to the parent process from the memory to execute a system starting procedure.

4. The method according to claim 1, wherein the predetermined start item comprises a system service, and the pre-read file list comprises the pre-read file list corresponding to the system service; and after recording the pre-read file list, the method further comprises:
before the system service starts in the subsequent target system starting process, pre-reading, by the pre-reading process, the data file corresponding to the system service into the memory from the pre-read file list corresponding to the system service according to the corresponding memory address;
loading, by the system service, the data file corresponding to the system service from the memory to execute a system starting procedure.

5. The method according to claim 3, wherein after recording the pre-read file list, the method further comprises:
generating, in a predetermined directory, a learning completion marker configured to indicate that the pre-read file list is valid;
wherein the method further comprises:
in the subsequent target system starting process, detecting, by the pre-reading process, whether the learning completion marker exists in the predetermined directory to obtain a detection result;
determining, by the pre-reading process, whether to execute a pre-reading mechanism corresponding to the pre-read file list based on the detection result.

6. The method according to claim 1, wherein after recording the pre-read file list, the method further comprises:
if detecting that a target system has been updated, then during a starting process of the target system after updating, collecting an updated peripheral loading event required by the predetermined start item according to the buried point in the kernel for the peripheral loading event of the predetermined start item;
obtaining an updated peripheral loading content corresponding to the updated peripheral loading event from the peripheral;
converting the updated peripheral loading content into the data file and the corresponding memory address for use by the predetermined start item, and generating an updated pre-read file list based on the data file and the corresponding memory address;
recording the updated pre-read file list.

7. The method according to claim 1, wherein after recording the pre-read file list, the method further comprises:
recording, in a specified directory, a scenario marker configured to indicate that a pre-reading mechanism is invalid under a scenario corresponding to the scenario marker;
wherein the method further comprises:
in the subsequent target system starting process, detecting, by the pre-reading process, whether a system is in the scenario corresponding to the scenario marker to obtain a scenario information;
determining, by the pre-reading process, whether to execute the pre-reading mechanism corresponding to the pre-read file list based on the scenario information.

8. The method according to claim 4, wherein after recording the pre-read file list, the method further comprises:
generating, in a predetermined directory, a learning completion marker configured to indicate that the pre-read file list is valid;
wherein the method further comprises:
in the subsequent target system starting process, detecting, by the pre-reading process, whether the learning completion marker exists in the predetermined directory to obtain a detection result;
determining, by the pre-reading process, whether to execute a pre-reading mechanism corresponding to the pre-read file list based on the detection result.

9. The method according to claim 1, wherein converting the peripheral loading content into the data file and the corresponding memory address for use by the predetermined start item, and generating a pre-read file list based on the data file and the memory address, comprises:
directly converting the current peripheral loading content into a data file and a corresponding memory address for use by the predetermined start item, and generating a pre-read file list based on the data file and the memory address.

10. The method according to claim 5, wherein determining, by the pre-reading process, whether to execute the pre-reading mechanism corresponding to the pre-read file list based on the detection result comprises:
if the detection result indicates that the learning completion marker exists, the pre-reading process preloads the data file into the memory in advance according to the pre-read file list;
conversely, if the detection result indicates that the learning completion marker does not exist, the pre-reading process does not preload the data file into the memory according to the pre-read file list.

11. The method according to claim 7, wherein determining, by the pre-reading process, whether to execute the pre-reading mechanism corresponding to the pre-read file list based on the scenario information comprises:
if the scenario information indicates that the system is not in the scenario corresponding to the scenario marker, the pre-reading process preloads the data file into the memory in advance according to the pre-read file list;
conversely, if the scenario information indicates that the system is in the scenario corresponding to the scenario marker, the pre-reading process does not preload the data file into memory according to the pre-read file list.

12. A system starting apparatus, comprising:
a collecting module configured to collect a target peripheral loading event required by a predetermined start item during a target system starting process according to a buried point in a kernel for a peripheral loading event of the predetermined start item;
an acquiring module configured to obtain a peripheral loading content corresponding to the target peripheral loading event from a peripheral;
a generating module configured to convert the peripheral loading content into a data file and a corresponding memory address for use by the predetermined start item, and to generate a pre-read file list based on the data file and the corresponding memory address;
a recording module configured to record the pre-read file list, wherein the pre-read file list is used in a subsequent target system starting process for a pre-reading process to pre-read the data file into a memory according to the corresponding memory address before the predetermined start item starts, and the data file is available for loading after the predetermined start item starts.

13. The apparatus according to claim 12, wherein the generating module is configured to: acquire a plurality of candidate peripheral loading contents, each of the candidate peripheral loading contents being acquired during one starting process of a target system; select an optimal peripheral loading content from among the plurality of candidate peripheral loading contents and a peripheral loading content; convert the optimal peripheral loading content into a data file and a corresponding memory address for use by the predetermined start item, and generate a pre-read file list based on the data file and the corresponding memory address.

14. The apparatus according to claim 12, wherein the predetermined start item comprises a parent process, and the pre-read file list comprises a pre-read file list corresponding to the parent process; the apparatus further comprises a first starting module, configured to: before the parent process starts in the subsequent target system starting process, pre-read, by the pre-reading process, the data file corresponding to the parent process into a memory from the pre-read file list corresponding to the parent process according to the corresponding memory address; and load, by the parent process, the data file corresponding to the parent process from the memory to execute a system starting procedure.

15. The apparatus according to claim 12, wherein the predetermined start item comprises a system service, and the pre-read file list comprises a pre-read file list corresponding to the system service; the apparatus further comprises a second starting module, configured to: before the system service starts in the subsequent target system starting process, pre-read, by the pre-reading process, the data file corresponding to the system service into a memory from the pre-read file list corresponding to the system service according to the corresponding memory address; and load, by the system service, the data file corresponding to the system service from the memory to execute a system starting procedure.

16. The apparatus according to claim 14, wherein the apparatus further comprises a learning marker generation module, configured to: generate, in a predetermined directory, a learning completion marker configured to indicate that the pre-read file list is valid; and further comprises a learning marker detection module, configured to: in the subsequent target system starting process, detect, by the pre-reading process, whether the learning completion marker exists in the predetermined directory to obtain a detection result; and determine, by the pre-reading process, whether to execute a pre-reading mechanism corresponding to the pre-read file list based on the detection result.

17. The apparatus according to claim 12, wherein the apparatus further comprises an updating module, configured to: if detecting that a target system has been updated, then during a starting process of the target system after updating, collect an updated peripheral loading event required by the predetermined start item according to the buried point in the kernel for the peripheral loading event of the predetermined start item; obtain updated peripheral loading content corresponding to the updated peripheral loading event from a peripheral; convert the updated peripheral loading content into a data file and a corresponding memory address for use by the predetermined start item, and generate an updated pre-read file list based on the data file and the corresponding memory address; and record the updated pre-read file list.

18. The apparatus according to claim 12, wherein the apparatus further comprises a scenario marker recording module, configured to: record, in a specified directory, a scenario marker configured to indicate that a pre-reading mechanism is invalid under a scenario corresponding to the scenario marker; and further comprises a scenario marker detection module, configured to: in the subsequent target system starting process, detect, by the pre-reading process, whether a system is in the scenario corresponding to the scenario marker to obtain a scenario information; and determine, by the pre-reading process, whether to execute the pre-reading mechanism corresponding to the pre-read file list based on the scenario information.

19. (canceled)

20. An electronic device, comprising: a memory storing a computer program; and a processor configured to read the computer program stored in the memory to:
during a target system starting process, collect a target peripheral loading event required by a predetermined start item according to a buried point in a kernel for a peripheral loading event of the predetermined start item;
obtain a peripheral loading content corresponding to the target peripheral loading event from a peripheral;
convert the peripheral loading content into a data file and a corresponding memory address for use by the predetermined start item, and generate a pre-read file list based on the data file and the corresponding memory address;
record the pre-read file list, wherein the pre-read file list is used in a subsequent target system starting process for a pre-reading process to pre-read the data file into a memory according to the corresponding memory address before the predetermined start item starts, and the data file is available for loading after the predetermined start item starts.

21. The electronic device according to claim 20, wherein the processor is configured to:
acquire a plurality of candidate peripheral loading contents, each of the candidate peripheral loading contents being acquired during one starting process of the target system;
select an optimal peripheral loading content from among the plurality of candidate peripheral loading contents and the peripheral loading content;
convert an optimal peripheral loading content into the data file and the corresponding memory address for use by the predetermined start item, and generate the pre-read file list based on the data file and the corresponding memory address.
